(19) United States
(12) Patent Application Publication
(10) Pub. No.: US 2013/0238360 A1
(43) Pub. Date: Sep. 12, 2013

(54) SYSTEM AND METHOD FOR MAINTAINING AND UTILIZING FAMILY MEDICAL HISTORY

(71) Applicant: Zibdy, Inc., San Diego, CA (US)

(72) Inventor: HIRDEY BHATHAL, San Diego, CA (US)

(21) Appl. No.: 13/789,481

(22) Filed: Mar. 7, 2013

Related U.S. Application Data
(60) Provisional application No. 61/609,219, filed on Mar. 9, 2012.

(51) Int. Cl. G06F 19/00

(52) U.S. Cl. CPC G06F 19/322
USPC 705/3

(57) ABSTRACT

A non-transitory computer readable medium having computer executable program code embodied thereon, the computer executable program code configured to cause a computing device to analyze a medication by: receiving a scanned barcode associated with the medication and authenticating the scanned code, wherein the barcode is scanned by a user using a mobile device; if no barcode exists or the barcode cannot be scanned, providing the user with the option of entering the medication name; recording the efficacy of or reaction to the medication with respect to the user; finding any family records of the user and searching for any adverse reactions to the medication within the family records; identifying past medications taken on the user's medications list; finding any medication—medication interactions between the scanned medication and past medications taken; and displaying the results to the user; and displaying the family medical history made up of family medications and indications, as well as efficacies and reactions for all members of a user's family network.

### CROSS-REFERENCE TO RELATED APPLICATIONS

This application claims the benefit of U.S. Provisional Patent Application No. 61/609,219 filed Mar. 9, 2012, the content of which is incorporated herein by reference in its entirety.

### FIELD OF THE INVENTION

The present invention relates to a system and method for maintaining and utilizing family medical history.

### DESCRIPTION OF THE RELATED ART

A number of solutions currently exist for providing interactive healthcare management and enhanced medical treatment for users. By way of example, U.S. Patent Publication No. 2008/0277307 describes an interactive electronic pillbox that includes a plurality of compartments containing medications along with a means to electronically identify a particular compartment from which medication is to be taken at a particular time. The interactive electronic pillbox includes data entry, data display, data transmitting and data processing functions that permit interactive healthcare management by individuals and healthcare personnel directly or remotely. This solution has been implemented at http://pillboxapp.com/. A similar solution can be found at www.pillphone.com, which holds lists of medications, checks for adverse reactions, and gives dosage reminders.

An additional solution is the Davis Drug Guide, which is designed to assist medical professionals with information on medications. (See http://itunes.apple.com/app/davis s-drug-guide/id301427093?mt=8). Medicine Central provides a further solution comprising a medicine reference for doctors and nurses. (See http://www.unboundmedicine.com/products/medicine_central. Further solutions include Harrison's Medical Manual, a reference on medicines (See http://www.unboundmedicine.com/products/harrisons_manual_medicine), and Family Drug Guide, a family medicines reference. (See http://www.unboundmedicine.com/products/family_drug_guide).

Another solution entails providing a medications marketplace. For example, BidRx is a site where users can manually enter medications list and compare vendor prices. (See https://www.bidrx.com/about_us/marketplace.html).

The following additional applications store medication lists and provide dosage reminders for individuals:

(i) http://group8020.com/mobile-medical-apps/top-3-prescription-drug-reminder-apps-5340/;
(ii) http://www.androidzoom.com/android_applications/medical/medication-log_bcwkf.html;
(iii) http://www.androidzoom.com/android_applications/medical/medication-reminder_jvvg.html;
(iv) http://www.androidzoom.com/android_applications/health_and_fitness/personal-medication-record_pmfa.html;
(v) http://www.androidzoom.com/android_applications/medical/medirem-medication-reminder_bxnbu.html;
(vi) http://www.androidzoom.com/android_applications/health_and_fitness/medication-log-free-medicine_bdsjq.html; and
(vii) http://www.medimemory.com/.

The following applications act as medicinal interactions checkers:

(i) http://www.medscape.com/public/iphone;
(ii) http://www.epocrates.com/mobile/iphone/rx; and
(iii) http://itunes.apple.com/app/skyscape-medical-resources/id293170168?mt=8.

### BRIEF SUMMARY OF EMBODIMENTS OF THE INVENTION

Embodiments of the invention provide to a system and method for maintaining and utilizing family medical history.

At the present time, there is no technology that collates, maintains or uses the family medical history of a set of blood related individuals. This is highlighted by the fact that a patient must fill out the same form every time he or she goes to their doctor for an examination. This form typically requests that the patient indicate personal illnesses, allergies (e.g. to vaccines) and family history events (e.g., family histories of heart disease, cancer, etc). The person also generally has their vitals (e.g., height, weight, etc.) measured every time they visit the doctor. There is currently no technology that allows patients to fill the above-identified information and store it in a location accessible from anywhere. Moreover, no technology exists for storing such information such that it can be maintained and updated as needed.

In addition to the issues noted above, current technology results in the details of the patient's medical history being lost when the patient dies, as medical records are not generally retained after a person's death. Embodiments of the invention address this issue.

Another problem involves ownership and control of medical information. At this time, despite U.S. law stating that an individual owns his or her medical information, this information (in the form of medical records and images) is actually controlled by the health insurance companies, hospitals, medical centers and doctor's offices. As a result, it is not portable or even readily available to the individual it applies to. This is a further issue addressed by embodiments of the invention.

A further problem is a result of the previously-identified issues—that an individual cannot have their own medical information combined with their family historical medical information in order to determine medical risks, and/or assist in diagnoses. This is yet another issue addressed by embodiments of the invention.

A further problem entails the management of medications used by patients. In particular, many patients take multiple (some more than 10) different medications, at different frequencies and dosages. Prescriptions for these medications must also be maintained, and vaccination schedules must also be followed. Additionally, the patients taking the medications are frequently either too young or too old to be able to maintain their medication themselves. Embodiments of the invention address all of these problems.

A problem associated with managing medications involves providing a solution enabling the easy and economical renewal of medications. There is currently no system available that would allow a user to quickly and conveniently assess the market for their medications. Moreover, there are no current solutions available that allow a user to enter a list of medications, vitamins and/or supplements, and automatically have vendors bid for the business of providing the items on the list. This is yet another issue addressed by embodiments of the invention.

Another problem is that drug companies sometimes need to recall certain production lots of their drugs for some reason. This is a further issue addressed by embodiments of the invention.

The complexity of medical information is yet another problem addressed by embodiments of the invention. The general public does not understand the complexity of medicine, and so cannot be expected to be able to deal with things like complex drugs or illnesses. Misunderstandings can have drastic consequences—such as that of a woman who misread a medication label, and suffered a stroke as a consequence (see, http://www.hc-sc.gc.ca/dhp-mps/medeff/bulletin/carn-bcei_v17n3-eng.php). Complex issues like drug interactions, the probabilities of family related illnesses, etc., are difficult for non-medics to understand.

Yet another problem addressed by embodiments of the invention involves data entry. Specifically, typing is not simple for everyone—particularly the elderly who are likely to have vision problems. Associated with this problem is the issue of personalization of the user interface. In particular, no system currently allows a user to modify the interface to suit the user's preferences or automatically adapt to users preferences or limitations. Embodiments of the invention allow the user to modify the user interface, for example, by increasing button and text sizes for the elderly, or adjusting colors for personal tastes.

Another problem entails the management of doctor appointments. Embodiments of the invention provide systems that facilitate keeping such appointments, as well as providing a means for the user to send the healthcare provider the appropriate, full or partial information required.

A further problem addressed by embodiments of the invention involves drug counterfeiting.

Another problem addressed by embodiments of the invention involves access to up to date information on available medications for particular illnesses. People generally do not know what medications are available for them, apart from what their doctor tells them.

An embodiment of the invention is directed toward a non-transitory computer readable medium having computer executable program code embodied thereon, the computer executable program code configured to cause a computing device to analyze a drug by: receiving a scanned barcode associated with the drug and authenticating the scanned code, wherein the barcode is scanned by a user using a mobile device; if no barcode exists or the barcode cannot be scanned, providing the user with the option of entering the drug name; recording the efficacy of or reaction to the drug with respect to the user; finding any family records of the user and searching for any adverse reactions to the drug; identifying past drugs taken on the user's medications list; finding any drug-drug interactions between the scanned drug and past drugs taken; and displaying the results to the user.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention.

FIG. 1 is a diagram illustrating an exemplary virtual pill box system in accordance with an embodiment of the invention.

FIG. 2 is a flowchart illustrating an algorithm for handling barcode scanning, in accordance with an embodiment of the invention.

FIG. 3 is a flowchart illustrating an algorithm for analyzing a drug, in accordance with an embodiment of the invention.

FIG. 4 is a flowchart illustrating an algorithm for identifying an unknown drug, in accordance with an embodiment of the invention.

FIG. 5 is a diagram illustrating an exemplary computing module that may be used to implement any of the embodiments disclosed herein.

These figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

Embodiments of the present invention are directed toward to a system and method for maintaining and utilizing family medical history. Particularly, some embodiments allow users to register and fill out a number of forms including, but not limited to, allergies, vitals, and what medications they are taking at the present time. These facts can be stored, for example, in a relational, cloud-based database, available from anywhere over the web. An embodiment of the invention includes voice recognition software that simplifies filling out this information.

Using an approach similar to LinkedIn, an embodiment of the invention allows users to set up networks of associates, some of whom can be registered as relatives (e.g., sister, father, etc.), and some simply as associates of whatever kind (e.g., doctor, caregiver etc.). The user can also give permissions to each of these associates as they see appropriate (e.g., read only to a parent, full control to a doctor and caregiver, and simply a registration of relationship to a sibling). These associations can then be used by algorithms on the server. These algorithms predict relatedness within the family network to connect related illnesses and treatments, e.g., heart disease in a grandfather and father influencing diagnosis in a son, including efficacies of medications in the older generations, as well as any adverse reactions therein. The family information can also be used to supply advertising information to the son to take preventative measures, such as Vitamin E. A powerful aspect of this network of relatives is that the addition of relevant family medical information can be carried out by individuals in the network as they become aware of it. In some embodiments, such information is immediately applied to all the relevant members of the network, including the preventative measures previously mentioned. As personal genome sequencing is increasing, an embodiment of the invention adds this information, thereby increasing the power of the relatedness predictive algorithms.

A further embodiment of the invention permits a user to create a registration for another person—for example an infant child or an elderly parent or grandparent. The infant or elderly person's email can be used to identify them. Additionally, it is possible for the creating user to hand off control of that account, either to the individual themselves (e.g., when the infant grows and reaches adulthood) or to another person such as another relative or caregiver. In some embodiments, the permissions can be set up so that more than one individual can have control of another user. By way of example, an elderly person who is being cared for at home could allow their three children as well as their primary physician and professional caregiver to have control of their account, to renew prescriptions, to record new medicines and any adverse events, etc.

According to an embodiment of the invention, when a user (either registered or not) chooses to buy a new medication (OTC or prescription), they can scan the medication's bar code (linear or 2D). This scan is read by the application, and the database is searched to return the medication, if found. If not, the user is given an opportunity to enter the medication, assisted by “helper” routines to assure correct spelling. Once the correct drug has been identified, it is searched against that user's current medications for allergies, family/personal adverse reactions and drug-drug interactions with any other drugs that individual has in their medications list—as well as for authenticity using the manufacturer's algorithms/web services. This authentication helps prevent drug counterfeiting—the manufacture of inactive copies of drugs by criminals—which is becoming an increasing problem.

Some embodiments of the invention entail working with drug manufacturers such as Pfizer and others in encrypting codes in 2D barcodes and checking them against a manufacturer provided database to authenticate a product. The drug ID information from the scan can be used to check against any drug recalls or label changes such as black box warnings as well. In addition, this information can be used to compare the location of the scan (e.g., using a GPS application on the mobile device) with an intended market/sales location for the drug in the 2D code. The user will be given the option of adding this drug to their medications list or not.

If this is the first use by a particular user who has not yet registered, they are given the opportunity to register using their email as a unique identifier. The user may also be surveyed occasionally to record the efficacy of medications, or reactions to such medications. This data can be stored in the database such that it is available immediately to algorithms determining a medication's effects on the user and others in his/her family relations network.

In one embodiment, when a particular medication is stored, the user is given the opportunity to record dosage frequency, as well as how long they will be taking the medication. With respect to a prescription, the user is asked how often they need to renew the prescription. At each stage, the user will have the opportunity to select whether and how they would like to be reminded of these schedules—which will assist with compliance. An embodiment of the invention also includes vaccination schedules, thus allowing young mothers, for example, to be able to manage their children's vaccinations correctly and effectively. An embodiment of the invention includes E-commerce capabilities to order and pay for medications, and have them delivered to the user.

An additional embodiment of the invention allows a user to offload reports of their account (allergies, current medications, reactions/efficacies of past medications, associated family illnesses, or a full report for this patient) either as an email or as a text document. Because this information is stored in a cloud-based database, it will be available anywhere in the world, at any time.

Further embodiments of the invention provide users with the ability to submit lists of medications, vitamins and supplements to a marketplace within application to obtain bids from vendors such as pharmacies. These bids may include the names of the subject medications, vitamins, and supplements, the package sizes (i.e., 30 tablets vs 90 tablets), as well as a description of the process and options offered (e.g., both with and without sales taxes and shipping charges, and options with expected time of delivery). Additional options might include store pickup options. If the patient selects the pharmacy bid, the system then shares patient insurance information and/or credit card information with the selected pharmacy to process the order. Alternatively, the system processes the order and sends the requisite information to the pharmacy. Depending on the user's selection of either a store pick-up option or a mail order option, the system provides the user with either a pick-up time or a tracking number.

An embodiment of the invention includes options for users to customize the interface. Such options may include, but are not limited to, options for altering button and text sizes, line spacing, fore and background coloring, and other interface personalization options. Further embodiments may feature providing predetermined options for particular users. Such options are provided to enhance the user experience for particular users, and may be selected without user involvement. By way of example, certain individuals, such as seniors, can be provided with a user interface that includes larger text sizes. Additionally, users from particular cultures, countries, or ethnic groups can be provided with a pre-selected user interface that is suitable for members of the particular culture, country or ethnic group.

Another embodiment of the invention allows the user to record doctor and medical insurance details. This information can be timestamped. No limit is placed on the number of doctors, dentists and other specialists to be recorded. When a previous doctor is dropped, this can be recorded along with appropriate dates and other information Likewise, the system may allow the user to record medical insurance information, which may also be timestamped. Doctor information that is recorded can include, but is not limited to, doctor name, email address, phone number and address. Insurance information can include, but is not limited to, company name, insurance number, and company phone number.

A further embodiment of the invention includes doctor appointment management tools. Such tools include, in various embodiments, the ability to record doctor appointments (for example at the time the appointment is set up). Subject the user's permissions, the user can save the appointment, or a designated relative or caregiver can save the appointment on behalf of the user. Additionally, the user may set up appointment reminders at user selected times. Based on the user's permissions, a complete or partial set of data held by the user (e.g., medications, vitals, allergies, medical history, family medical history etc.) can be emailed by the system to the healthcare provider or other medical practitioner. This information can be specific to the particular appointment. Such information can be sent to the healthcare provider the day before the appointment is to take place or any other time selected by the user or authorized caregiver, such that the physician's office will have all the relevant patient (and family) data, including insurance information to sign when the user arrives.

Embodiments of the invention involve the use of personal medical data. Due to this fact, the databases are maintained in a HIPAA compliant manner, and all transmissions of personally identifiable data to the appropriate clients are encrypted.

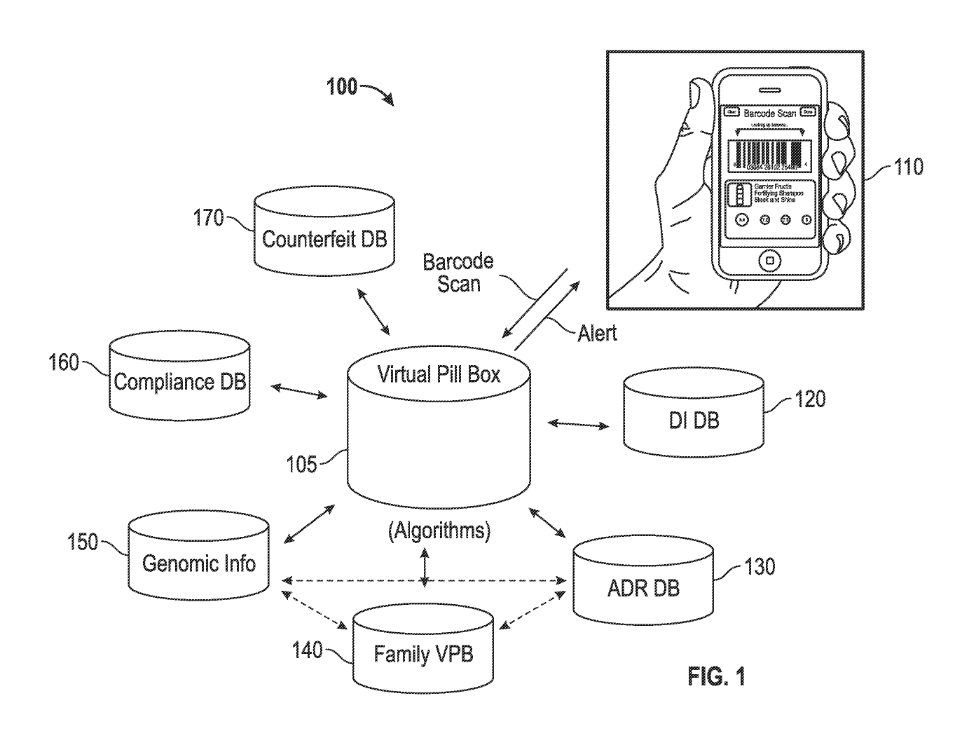

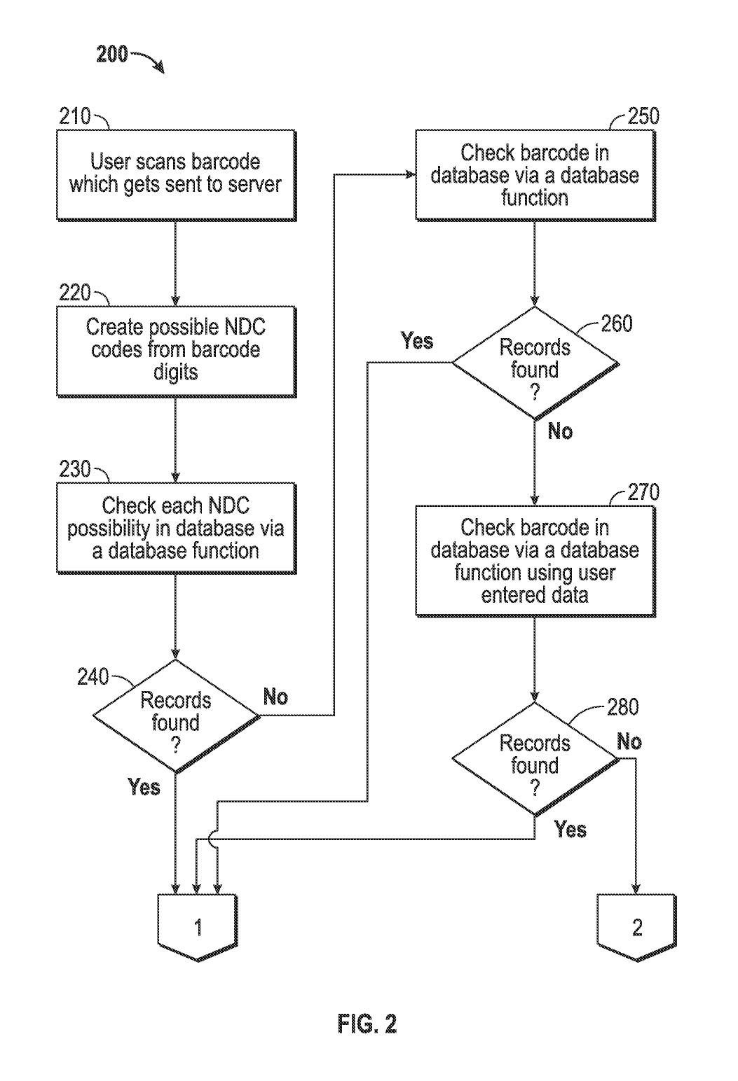

Referring to FIG. 1, an exemplary virtual pill box system 100 in accordance with an embodiment of the invention will now be described. In particular, the virtual pill box system 100 is a cloud-based system, with data being sent between mobile device 110 and the cloud. Barcode scanning is performed using an application residing on the mobile device 110 and associated with the application residing on virtual pill box 105. The algorithm which the system 100 uses to handle barcode scanning is described hereinbelow with respect to FIG. 2 (scanning process flowchart). In operation, the virtual pill box 105 can access a number of databases, including without limitation: drug interactions (DI) database 120, adverse drug reaction (ADR) database 130, family virtual pill box database 140, genomic information database 150, compliance database 160, and counterfeit database 170.

With further reference to FIG. 1, once a scanned drug has been identified, the server side logic uses this data as follows. Authentication is carried out using manufacturer supplied authentication data and/or web services. In some embodiments, a 2D barcode associated with the drug includes information by manufacturers indicating the market for which the drug is intended. In these embodiments, the mobile device's GPS system can be used to locate where the drug is scanned, and the user can be warned if the scanning location is different from the intended market for that drug. Compliance is enabled by allowing the user to record the frequency with which they need to take the drug, as well as when a prescription must be renewed. Genomic sequence and/or important loci found can be searched within genomic information database 150. Accordingly, if for example a locus is found implying a particular drug will not work, the patient with this genomic information available can be warned.

Similar to the genomic database 150, family VPB database 140 can be used to provide important information to the user. By way of example, the user can be warned if a relative has had a bad reaction to a medicine. The ADR database 130 may also be employed in such circumstances to provide information regarding adverse drug effects. Family VPB information is added to the family VPB database 140 by each individual family member, in their own account. It is related by the user “Inviting” members of his or her family to join his network, indicating their relationship (parent, sibling, child, etc.). Virtual pill box server logic can use this relationship to build the user's family network.

With continued reference to FIG. 1, the DI database 120 enables the patient's drugs to be searched in order to determine whether the most recently entered drug has a Major, Moderate or Mild interaction with any of the previously entered drugs. Once the user is satisfied with their drug choice, the server logic allows them to save their choice in their own medications list, in a database on the server.

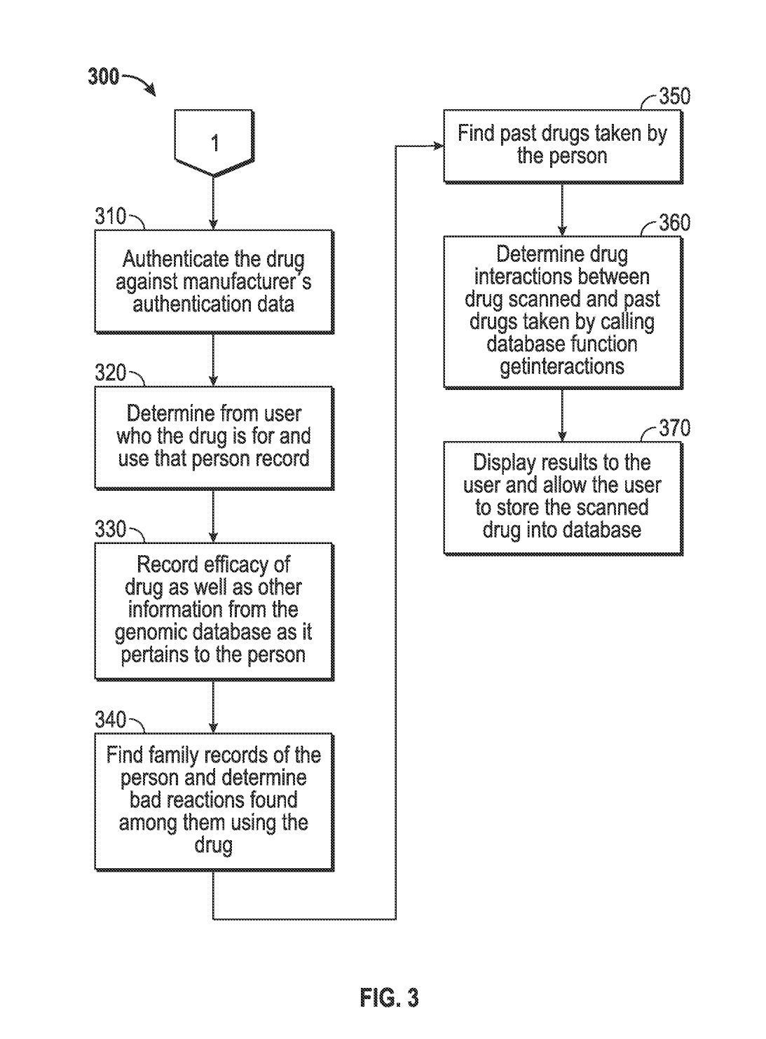

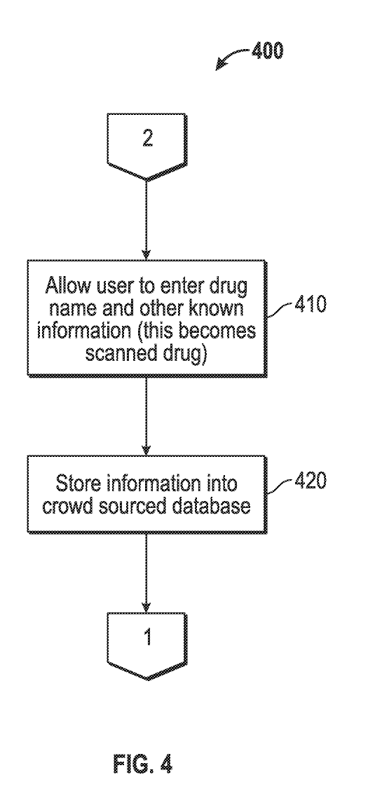

Referring to FIG. 2, a flowchart 200 is provided to illustrate an algorithm that the system 100 uses to handle barcode scanning, in accordance with an embodiment of the invention. Specifically, operation 210 involves the user scanning a barcode with mobile device 110 and sending the universal product code (UPC) back to the server. In operation 220, the server software creates a possible national drug code (NDC) from the UPC. Further embodiments of the invention include systems to generate and use the appropriate codes employed in other countries. The user device GPS application can be used here. Operation 230 entails the user searching for the NDC using, for example, a function which gets AIs in the database, where “AI” refers to the active ingredient of the drug. If found in operation 240, the method proceeds to the flowchart of FIG. 3. If not, the method proceeds to operation 250, wherein the system 100 checks the barcode in the database using function calls to get AIs from the UPC. If found in operation 260, the method proceeds to the flowchart of FIG. 3. If not, the method proceeds to operation 270, wherein the system 100 checks the barcode in the database in an attempt to get user entered data using a function call to get AIs from user entered data. If the records are found in operation 280, the method proceeds to the flowchart of FIG. 3. If not, the user is prompted to enter details for this scanned UPC and store it in a user entered data table. In this case, the method then proceeds to the flowchart of FIG. 4.

Referring to FIG. 3, a flowchart 300 is provided to illustrate an algorithm that the system 100 uses to analyze a drug, in accordance with an embodiment of the invention. Particularly, operation 310 entails using the manufacturer's authentication data (e.g., algorithm, database, web services, etc.) in order to authenticate the scanned code. Operation 320 involves asking the user whether the drug is for the user or for another person. In operation 330, the system 100 records the efficacy of the drug with respect to the person, and retrieves any relevant information from the genomic information database 150 that might pertain to the person. Operation 340 entails the system 100 finding any family records of the person for whom the drug is intended using the family VPB database 140 and searching for any adverse reactions in the ADR database 130. Operation 350 entails identifying past drugs taken on the person's medications list. In operation 360, a function querying Interactions is employed to find any drug-drug interactions between the scanned drug and past drugs taken. Operation 370 entails displaying the results to the user, and allowing the user the option to store the results. The system then allows the user to choose to exit the application, or go back to the method of FIG. 2.

Referring to FIG. 4, a flowchart 400 is provided to illustrate an algorithm that the system 100 uses to identify an unknown drug, in accordance with an embodiment of the invention. Operation 410 involves the system 100 allowing the user to enter all available drug details (e.g., name, manufacturer, active ingredients, UPC, NDC, etc.). This becomes the scanned drug. In operation 420, the system stores the data in the crowd sourced drugs database. The system then reverts back to the method of FIG. 3.

In accordance with various embodiments of the invention, a number of database functions used herein will now be described. A function querying the NAME takes a single parameter comprising a drug name, and searches for the AIs in the AI table linked to the drug name, via the table linking products and AIs. If none are found, then the function searches for AIs for the “real name” drug in the AI table, using the table linking products and AIs, and returns the table of AIs with drug name, UPC and NDC (if any exist). A function querying the NDC takes a single parameter comprising a drug NDC via the table linking products to AIs, searches for the AIs in the AI table linked to the drug NDC, and returns the table of AIs with drug name, UPC and NDC (if any exist)

Another function, querying the UPC, takes a single parameter comprising a drug UPC, searches for the AIs in the AI table linked to the drug UPC, via the tble linking products to AIs, and returns the table of AIs with drug name, UPC and NDC (if any exist). A function querying Interactions takes 2 parameters including drug1 and drug2 (which are drug active ingredients), searches the interactions table for interactions between these two drugs, and returns the severity (Major, Moderate, Minor or NULL). The translate function takes 1 parameter comprising a drug name not found in the products, searches the analog drug names table for an analog like the input parameter, and returns the NAME (which may be NULL).

Additional embodiments of this invention may entail the following functions without limitation: (i) inclusion and use of personal genome sequences; (ii) inclusion of E-commerce options; (iii) inclusion of all aspects of 2D barcode technology; and (iv) inclusion of manufacturer authentication functions, which will change as the counterfeiters change.

As used herein, the term “set” may refer to any collection of elements, whether finite or infinite. The term “subset” may refer to any collection of elements, wherein the elements are taken from a parent set; a subset may be the entire parent set. The term “proper subset” refers to a subset containing fewer elements than the parent set. The term “sequence” may refer to an ordered set or subset. The terms “less than,” “less than or equal to,” “greater than,” and “greater than or equal to,” may be used herein to describe the relations between various objects or members of ordered sets or sequences; these terms will be understood to refer to any appropriate ordering relation applicable to the objects being ordered.

The term “tool” can be used to refer to any apparatus configured to perform a recited function. For example, tools can include a collection of one or more modules and can also be comprised of hardware, software or a combination thereof. Thus, for example, a tool can be a collection of one or more software modules, hardware modules, software/hardware modules or any combination or permutation thereof. As another example, a tool can be a computing device or other appliance on which software runs or in which hardware is implemented.

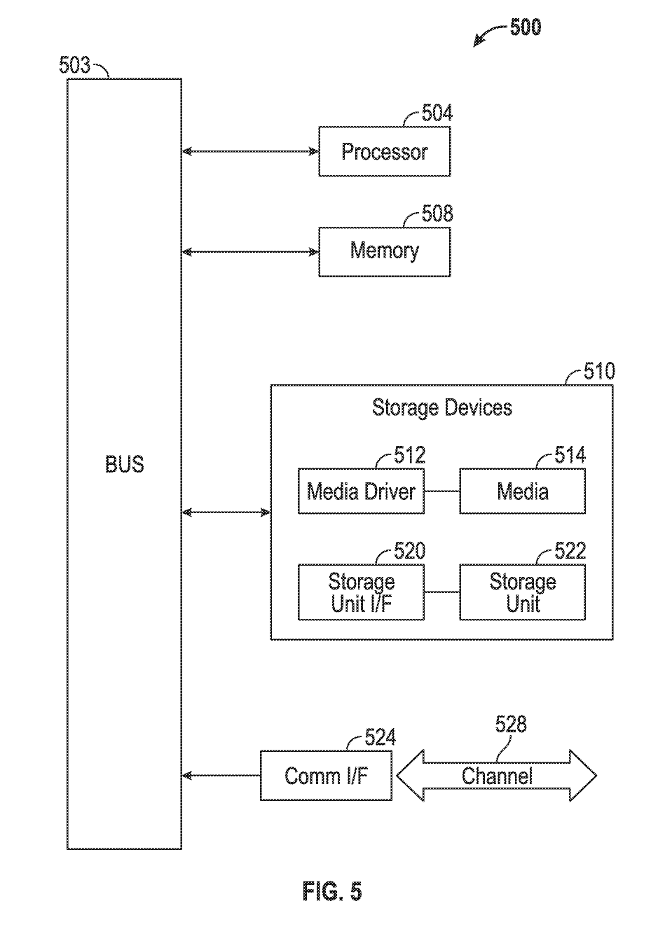

As used herein, the term “module” might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 5. Various embodiments are described in terms of this example-computing module 500. After reading this description, it will become apparent to a person skilled in the relevant art how to implement the invention using other computing modules or architectures.

Referring now to FIG. 5, computing module 500 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 500 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 500 might include, for example, one or more processors, controllers, control modules, or other processing devices, such as a processor 504. Processor 504 might be implemented using a general-purpose or special-purpose processing engine such as, for example, a microprocessor, controller, or other control logic. In the illustrated example, processor 504 is connected to a bus 503, although any communication medium can be used to facilitate interaction with other components of computing module 500 or to communicate externally.

Computing module 500 might also include one or more memory modules, simply referred to herein as main memory 508. For example, preferably random access memory (RAM) or other dynamic memory, might be used for storing information and instructions to be executed by processor 504. Main memory 508 might also be used for storing temporary variables or other intermediate information during execution of instructions to be executed by processor 504. Computing module 500 might likewise include a read only memory (“ROM”) or other static storage device coupled to bus 503 for storing static information and instructions for processor 504.

The computing module 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a floppy disk drive, a magnetic tape drive, an optical disk drive, a CD, DVD or Blu-ray drive (R or RW), or other removable or fixed media drive might be provided. Accordingly, storage media 514 might include, for example, a hard disk, a floppy disk, magnetic tape, cartridge, optical disk, a CD, DVD or Blu-ray, or other fixed or removable medium that is read by, written to or accessed by media drive 512. As these examples illustrate, the storage media 514 can include a non-transitory computer readable medium having computer executable program code embodied thereon.

In alternative embodiments, information storage mechanism 510 might include other similar instrumentalities for allowing computer programs or other instructions or data to be loaded into computing module 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory module) and memory slot, a PCMCIA slot and card, and other fixed or removable storage units 522 and interfaces 520 that allow software and data to be transferred from the storage unit 522 to computing module 500.

Computing module 500 might also include a communications interface 524. Communications interface 524 might be used to allow software and data to be transferred between computing module 500 and external devices. Examples of communications interface 524 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 524 might typically be carried on signals, which can be electronic, electromagnetic (which includes optical) or other signals capable of being exchanged by a given communications interface 524. These signals might be provided to communications interface 524 via a channel 528. This channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 500 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A non-transitory computer readable medium having computer executable program code embodied thereon, the computer executable program code configured to cause a computing device to analyze a medication by:
receiving a scanned barcode associated with the medication and authenticating the scanned code, wherein the barcode is scanned by a user using a mobile device;
if no barcode exists or the barcode cannot be scanned, providing the user with the option of entering the medication name;
recording an efficacy of or reaction to the medication with respect to the user;
finding any family records of the user and searching for any adverse reactions to the medication within the family records;
identifying any past medications taken on a medications list of the user;
finding any medication—medication interactions between the scanned medication and past medications taken; and
displaying the results to the user.

2. The computer readable medium of claim 1, further comprising receiving a list of user medications, and obtaining bids from vendors for delivering the user medications.

3. The computer readable medium of claim 1, further comprising providing user options for the user to customize a user interface.

4. The computer readable medium of claim 1, further comprising prompting the user to record doctor and medical insurance details.

5. The computer readable medium of claim 4, further comprising timestamping the recorded doctor and medical insurance details.

6. The computer readable medium of claim 1, further comprising providing the user with doctor appointment management tools including an ability to record doctor appointments.

7. The computer readable medium of claim 6, further comprising sending a complete or partial set of data held by the user, including medications, vitals, allergies, medical history, and family medical history, to a doctor associated with the recorded doctor appointment.

8. The computer readable medium of claim 7, wherein sending the complete or partial set of data comprises sending the data the day before the recorded doctor appointment is to take place.

9. The computer readable medium of claim 1, further comprising providing the user an opportunity to record a dosage frequency and a duration for taking the medication.

10. The computer readable medium of claim 1, further comprising allowing the user to offload reports of their account, wherein the reports include information regarding allergies, current medications, reactions and efficacies of past medications, and associated family illnesses.

11. A system, comprising:
a virtual pill box including a virtual pill box application that allows data to be transmitted between a mobile device of a user and a cloud;
a mobile device application associated with the virtual pill box application that is used to perform barcode scanning;
a plurality of databases that are accessible by the virtual pill box, wherein the databases are selected from the group consisting of: a medications database, a medication interactions database, an adverse medication reaction database, a family virtual pill box database, a genomic information database, a compliance database, and a counterfeit database.

12. The system of claim 11, wherein the mobile device is employed to identify a medication by scanning a barcode associated with the medication.

13. The system of claim 12, wherein the virtual pill box application performs an authentication using manufacturer supplied authentication data and/or web services.

14. The system of claim 12, wherein the barcode comprises a two-dimensional barcode associated with the drug includes information by manufacturers indicating the market for which the medication is intended.

15. The system of claim 11, wherein the plurality of databases comprises a genomic information database that includes searchable genomic sequences or loci.

16. The system of claim 11, wherein the plurality of databases comprises a family virtual pill box database used to identify whether the user has family history indicating an adverse reaction to a particular medicine.

17. The system of claim 11, wherein the plurality of databases comprises an adverse drug reaction database used to identify whether the user has a personal history of an adverse reaction to a particular medication.

18. The system of claim 11, wherein the plurality of databases comprises a medication interactions database that determines whether the user's most recently entered medication has a known interaction with any previously entered medication.

19. The system of claim 11, further comprising a marketplace application that allows the user to submit a list of medications, vitamins and supplements.

20. The system of claim 19, wherein the marketplace application is used to obtain vendor bids for delivery of the medications, vitamins and supplements.

21. The system of claim 20, further comprising a means for creating a real time family medical history that allows the system to connect family members in a family tree and share their medical histories.

22. The system of claim 21, wherein family medical histories are shared based on a permission system, whereby two family members are only linked upon mutual permission, and wherein either of the two family members has an option to break the link and terminate the sharing of medical histories.

23. The system of claim 21, wherein a user's medical history is shared with a non-family member based on a permission system, whereby the non-family member is linked to the user by defining a specific relationship between the user and the non-family member, and wherein the non-family member is a caregiver, healthcare provider or social worker.

24. The system of claim 11, further comprising a means for a primary account holder to create any number of sub-accounts, wherein when the sub-accounts are converted in to a primary accounts, all relevant data in the sub-accounts and defined family relations relative to the sub-accounts are transferred to the primary account.
